(19) United States
(12) Patent Application Publication
(10) Pub. No.: US 2018/0220623 A1
(43) Pub. Date: Aug. 9, 2018

(54) APPARATUS FOR CONTROLLING PET

(71) Applicant: MUAHCHOAH Limited, Wonju-si (KR)

(72) Inventor: Myung Ho Chu, Wonju-si (KR)

(73) Assignee: MUAHCHOAH Limited, Wonju-si (KR)

(21) Appl. No.: 15/883,857

(22) Filed: Jan. 30, 2018

(30) Foreign Application Priority Data
Feb. 8, 2017 (KR) 10-2017-0017578

(51) Int. Cl. A01K 15/04

(52) U.S. Cl. CPC A01K 15/04

(57) ABSTRACT

An exemplary embodiment of the present disclosure provides an apparatus for controlling a pet by improving self-regulation and convenience for an owner when he/she lives indoor or goes out with the pet. The apparatus can include a driving module connected to a first belt wound between the neck and the front feet of a pet, a second belt wound around the chest and back of the pet, and a third belt wound around the stomach and back of the pet to pull or release at least one of the first belt, the second belt, and the third belt; a controller receives and transmits control signals from an electronic device to driving units; a case for the driving module and the controller; and a wearing part that is coupled to the case, the first belt, the second belt, and the third belt to be worn on the pet.

### CROSS-REFERENCE TO RELATED APPLICATION

This application claims priority to and the benefit of Korean Patent Application No. 2017-17578, filed on Feb. 8, 2017, the disclosure of which is incorporated herein by reference in its entirety.

### BACKGROUND OF THE INVENTION

### Field of the Invention

The present invention relates to an apparatus for controlling a pet, more particularly, to an apparatus for controlling a pet which is possible to wirelessly control the pet, thus making it possible to improve self-regulation of a pet and convenience for an owner when he/she lives indoor or goes out with the pet.

### Description of the Related Art

Recently, as the quality of life is improved and two or less-person households have been increased, homes keeping pets such as dogs and cats like families have been increased with each passing day, so the revenue of the related businesses has also been steadily increased.

However, there is a need for a means for controlling the action radius of pets and preventing separation of them to easily control them when living indoor or going out for a walk with them.

In most cases, owners of pets have physically controlled their pets with an end of a string for pets connected to a neck strap on the pets and the other end in their hands.

However, with the development of electronic devices such as a smartphone and down-sizing of various devices, studies for wirelessly controlling pets to increase self-regulation of pets and convenience for owners are continuously increased.

A system for training animals has been disclosed in Korean Patent Application Publication No. 10-2016-0069148 (titled, “System for Animal Training and Method Thereof). The system includes: a smart device that supports communication with a transmitter through a specific application (APP), monitors in real time the operation state and location of a receiver, and transmits a control signal for generating at least one of electric shock, vibration shock, and voice output for controlling the operation of a receiver when the receivers goes out of a predetermined control range; a transmitter that receives and transmits various control signals from the smart device to the receiver when connected to the smart device through the specific application; and a receiver that receives the control signals from the transmitter and generates at least one of the electric shock, vibration shock, or voice output corresponding to the control signals.

### CITATION LIST

### Patent Literature

Patent Literature 1: Korean Patent Application Publication No. 10-2016-0069148

### SUMMARY OF THE INVENTION

In order to solve these problems, an object of the present invention is to put an apparatus, which can wirelessly control a pet using an electronic device such as a smartphone or a remote controller, on a pet.

Another object of the present invention is to provide an apparatus for controlling a pet, the apparatus having simple configuration and a small size.

The technical subject to implement in the present invention are not limited to the technical problems described above and other technical subjects that are not stated herein will be clearly understood by those skilled in the art from the following specifications.

In order to achieve the objects of the present invention, an apparatus for controlling a pet includes: a driving module that is connected to a first belt wound between the neck and the front feet of a pet, a second belt wound around the chest and back of the pet, and a third belt wound around the stomach and back of the pet to pull or release at least one of the first belt, the second belt, and the third belt; a controller that receives and transmits control signals from an electronic device to driving units; a case in which the driving, module and the controller are disposed; and a wearing part that is coupled to the case, the first belt, the second belt, and the third belt, and to be worn on the pet.

According to an embodiment of the present invention, the driving module may include: a moving body that has a first hole at the upper portion and a second hole formed at the lower portion with the central axis perpendicular to the central axis of the first hole and is coupled to the first belt, the second belt, and the third belt to move forward/rearward and left and right; a first guide that is disposed through the first hole; a second guide that is disposed through the second hole; a pair of first driving units that is coupled to both ends of the first guide to move straight the moving body forward/rearward; and a pair of second driving units that is coupled to both ends of the second guide to move straight the moving body left/right.

According to an embodiment of the present invention, the first driving units each may include: a first driving belt that is coupled to the first guide on the outer side and has teeth on the inner side; a first motor unit that has a first gear engaged with teeth on the inner side of the first driving belt and drives the first driving belt by rotating the first gear; and first sensing units that sense motion of the first guide.

According to an embodiment of the present invention, the second driving units each may include: a second driving belt that is coupled to the second guide on the outer side and has teeth on the inner side; a second motor unit that has a second gear engaged with teeth on the inner side of the second driving belt and drives the second driving belt by rotating the second gear; and second sensing units that sense motion of the second guide.

According to an embodiment of the present invention, the driving module may include: a first motion guide that is elongated left and right; a first slit that is formed in the longitudinal direction on the first motion guide and has teeth on a portion thereof; a second motion guide that is spaced from the first motion guide and elongated left and right; a second slit that is formed in the longitudinal direction on the second motion guide; a first moving body that is engaged with the first slit and coupled to the second slit to move straight left and right; and a second moving body that is inserted in a hole formed through the first moving body and to be coupled to the first moving body and is coupled to the first belt, the second belt, and the third belt to move straight forward and rearward.

According to an embodiment of the present invention, the first moving body may have: a third slit that is formed on a first side of the hole with teeth on a portion thereof; a fourth slit that is formed on a second side facing the first side of the hole; a first moving gear that is engaged with the teeth of the first slit and provides force to the first moving body by rotating by a first motion motor; and a first projection that is coupled to the second slit to maintain the motion direction of the first moving body.

According to an embodiment of the present invention, the second moving body may have: a second moving gear that is engaged with the teeth of the third slit and provides force to the second moving body by rotating by a second motion motor; and a second projection that is coupled to the fourth slit to maintain the motion direction of the second moving body.

According to an embodiment of the present invention, the apparatus may further include a third driving unit that includes a cover unit covering the mouth of the pet, a stretcher unit coupled to the cover unit and changing in length to operate the cover unit, and a third motor unit providing force for contracting the stretcher unit.

According to an embodiment of the present invention, the apparatus may further include leg restrictors that are connected to a wire coupled to the third motor unit and restrict legs of the pet by moving to joints of the legs of the pet from the upper parts of the legs of the pet.

According to an embodiment of the present invention, the apparatus may further include a sensor unit that is disposed in the case, includes a plurality of position sensors, and transmits information about distances between the electronic device and each of the position sensors to the controller.

### BRIEF DESCRIPTION OF THE DRAWINGS

FIG. 1 is a view showing a pet wearing an apparatus for controlling a pet according to an embodiment of the present invention;

FIG. 2 is a perspective view of a driving module according to an embodiment of the present invention;

FIGS. 3A and 3B are plan views of the driving module according to an embodiment of the present invention;

FIGS. 4A and 4B are views showing the configuration of moving body and a first driving unit according to an embodiment of the present invention;

FIG. 5 is a perspective view of a driving module according to another embodiment of the present invention;

FIG. 6 is a side view of the driving module according to another embodiment of the present invention;

FIG. 7 is a plan view of the driving module according to another embodiment of the present invention;

FIGS. 8A and 8B are views showing the internal structure of a third driving unit according to an embodiment of the present invention; and

FIG. 9 is a plan view of a wearing part according to an embodiment of the present invention.

### DETAILED DESCRIPTION OF THE PREFERRED EMBODIMENTS

Hereinafter, the present invention is described with reference to the accompanying drawings. However, the present invention may be modified in various different ways and is not limited to the embodiments described herein. Further, in the accompanying drawings, components irrelevant to the description will be omitted in order to clearly describe the present invention, and similar reference numerals will be used to describe similar components throughout the specification.

Throughout the specification, when an element is referred to as being “connected with (coupled to, combined with, in contact with)” another element, it may be “directly connected” to the other element and may also be “indirectly connected” to the other element with another element intervening therebetween. Throughout the present specification, unless explicitly described otherwise, “comprising” any components will be understood to imply the inclusion of other components rather than the exclusion of any other components.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Hereinafter, the present invention is described in detail with reference to the accompanying drawings.

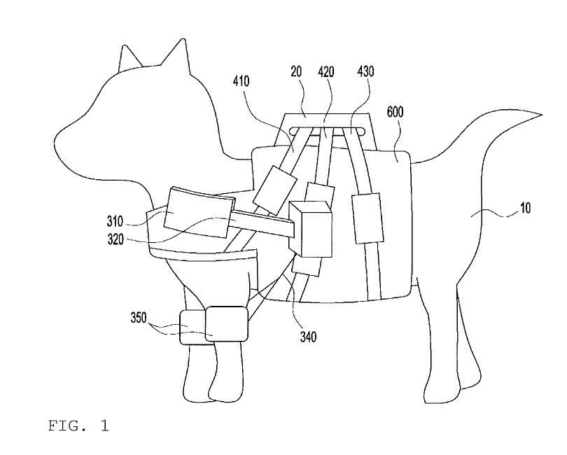

FIG. 1 is a view showing a pet 10 wearing an apparatus for controlling a pet according to an embodiment of the present invention.

(In the embodiment, the head, tail, left side, and right side of the pet 10 are may be defined respectively, as ‘front’, ‘rear’, ‘left’, and ‘right’. This is the same in the following description. Further, the front, rear, left and right may be indicated by F, B, L, and R in the drawings.)

The apparatus for controlling a pet of the present invention is exaggerated in size in the drawings for the convenience of understanding, but it may be manufactured in a small size not to give the pet 10 wearing the apparatus inconvenience.

As shown in FIG. 1, the apparatus for controlling a pet of the present invention may include: a driving module that is connected to a first belt 410 wound between the neck and the front feet of the pet 10, a second belt 420 wound around the chest and back of the pet 10, and a third belt 430 wound around the stomach and back of the pet 10 to pull or release at least one of the first belt 410, the second belt 420, and the third belt 430; a controller 500 that receives and transmits control signals from an electronic device to driving units; a case 20 in which the driving module and the controller 500 are disposed; and a wearing part 600 that is coupled to the case 20, the first belt 410, the second belt 420, and the third belt 430, and to be worn on the pet 10.

In the embodiment of the present invention, the case 20 is supposed to be positioned on the back of the pet 10, but the present invention is not limited thereto.

A sound unit that transmits voice information recognized from the electronic device to the pet 10 or recognizes and transmits sound made by the pet 10 to the electronic device may be disposed in the case 20. An owner of the pet 10 can give instructions to the pet 10 through the sound unit or the controller 500 can transmit a signal to the sound unit so that the sound unit generates an alarm when a problem occurs.

The apparatus for controlling a pet of the present invention may be operated by electricity, and to this end, it may include a battery. The battery may be disposed in the case 20, but the present invention is not limited thereto. The battery may be detachably attached to the inner side of the wearing part 600 that is brought in contact with the pet 10 to be easily replaceable.

The case 20 may be made of synthetic resin or light metal such as aluminum to minimize the weight of the apparatus for controlling a pet of the present invention.

An embodiment of the driving module is described hereafter.

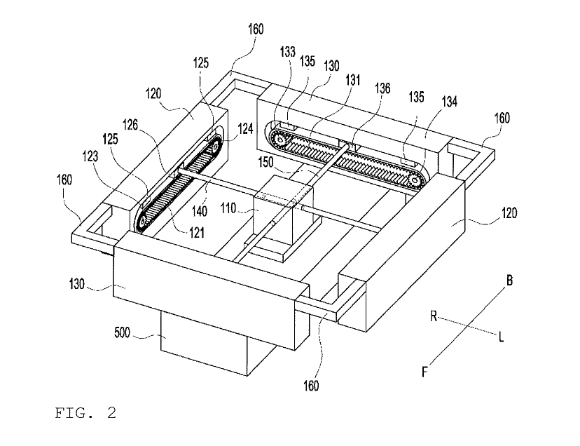

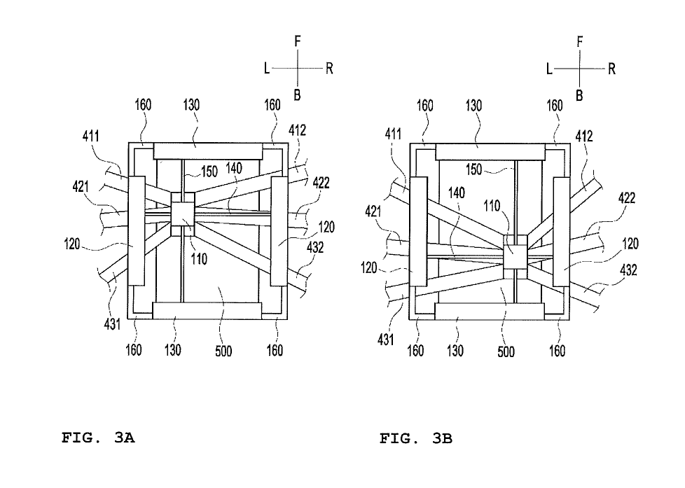

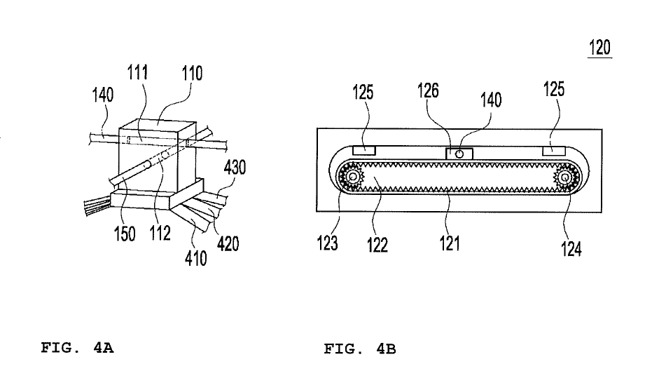

FIG. 2 is a perspective view of the driving module according to an embodiment of the present invention and FIGS. 3A and 3B are plan views of the driving module according to an embodiment of the present invention. FIGS. 4A and 4B are views showing the configuration of moving body 110 and a first driving unit 120 according to an embodiment of the present invention.

FIG. 3A shows the moving body 100 moved forward and left from the center position and FIG. 3B shows the moving body 110 moved rearward and right from the center position.

FIG. 4A is a perspective view of the moving body 110 and FIG. 4B is a side view of the first driving unit 120 (the side view of a second driving unit 130 is the same as the side view of the first driving unit 120).

As shown in FIGS. 2 to 4, the driving module may include: the moving body 110 that has a first hole 111 at the upper portion and a second hole 112 formed at the lower portion with the central axis perpendicular to the central axis of the first hole 111 and is coupled to the first belt 410, the second belt 420, and the third belt 430 to move forward/rearward and left and right; a first guide 140 that is disposed through the first hole 111; a second guide 150 that is disposed through the second hole 112; a pair of first driving units 120 that is coupled to both ends of the first guide 140 to move straight the moving body 110 forward/rearward; and a pair of second driving units 130 that is coupled to both ends of the second guide 150 to move straight the moving body 110 left/right.

The first driving units 120 each may include: a first driving belt 121 coupled to the first guide 140 on the outer side and having teeth on the inner side; a first motor unit 122 having a first gear 123 engaged with the first driving belt 121 and driving the first driving belt 121 by rotating the first gear 123; and first sensing units 125 that sense motion of the first guide 140.

The second driving units 130 each may include: a second driving belt 131 coupled to the second guide 150 on the outer side and having teeth on the inner side; a second motor unit 132 having a second gear 133 engaged with the second driving belt 131 and driving the second driving belt 131 by rotating the second gear 133; and second sensing units 135 that sense motion of the second guide 150.

Since the first guide 140 coupled to the first driving units 120 is positioned higher than the second guide coupled to the second driving units 130, the first driving units 120 can be installed higher than the second driving units 130.

The first driving unit 120 and the second driving units 130 may be coupled to each other by a frame 160. The first driving units 120 may be coupled to the controller 500 that also functions as a main body. Accordingly, the pair of first driving units 120 and the pair of second driving units 130 can be fixed at their positions.

When the second guide 150 is moved by the second driving unit 130, the moving body 110 can be moved straight on the first guide 140 disposed through the first hole 111 by force from the second guide 150. Further, when the first guide 140 is moved by the first driving units 120, the moving body 110 can be moved straight on the second guide 150 disposed through the second hole 112. A lubricant may be supplied to the contact surfaces between the first hole 111 and the first guide 140 and between the second hole 112 and the second guide 140 to reduce friction on the surfaces.

Further, as shown in FIG. 4A, the first belt 410, second belt 420, and third belt 430 are coupled to the moving body 110, so the belt can be pulled and released by motion of the moving body 110.

The movements of the first guide 140 and the second guide 150 may be separately performed, or may be simultaneously performed, as shown in FIG. 3.

Although one moving body 110 is provided in an embodiment of the present invention, as another embodiment, a first moving body through which the first guide 140 is disposed and a second moving body through which the second guide is 150 is disposed may be provided, a 1-1 belt 411, a 2-1 belt 421, and a 3-1 belt 432 may be connected to the first moving body, and a 1-2 belt 412, a 2-2 belt 422, and a 3-2 belt 432 may be connected to the second moving body. Accordingly, the effect by the moving body 110 can be equivalently achieved by the motion of the first moving body and the second moving body.

A first coupling portion 126 is formed on the outer side of the first driving belt 121 so that the first driving belt 121 is coupled to a first end of the first guide 140. The first sensing units 125 can sense the position of the moving body 110 by sensing the position of the first coupling portion 126 coupled to the first end of the first guide 140.

The teeth formed on the inner side of the first driving belt 121 and the first gear 123 are engaged with each other, so the first driving belt 121 can be moved clockwise or counterclockwise by rotation of the first gear 123. A first auxiliary gear 124 that is not powered and engaged with the teeth on the inner side of the first driving belt 121 may be disposed at a predetermined distance from the first gear 123. The first auxiliary gear 124 is connected to the first gear 123 through the first driving belt 121, so it can allow the first driving belt 121 at a predetermined position by being rotated by rotation of the first gear 123 (obviously, a second auxiliary gear 134 and a second coupling portion 136 are included in the second driving unit 130 and perform the same function as the first auxiliary gear 124 and the first coupling portion 126).

The configuration of the first driving unit 120 can be applied in the same way to the second driving unit 130. The first driving unit 120 and the second driving unit 130 have the same configuration, but the movement directions and positions of the guides may be different.

Another embodiment of the driving module is described hereafter.

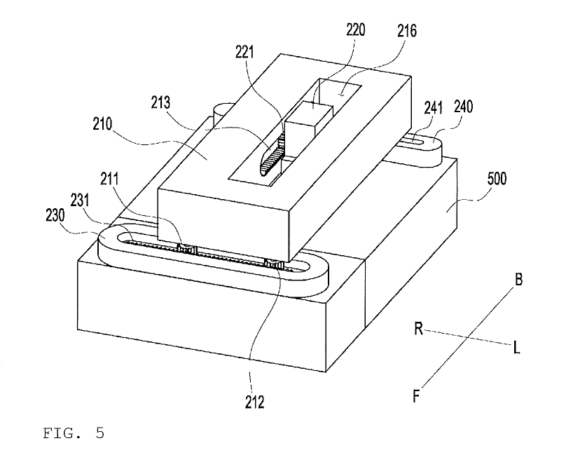

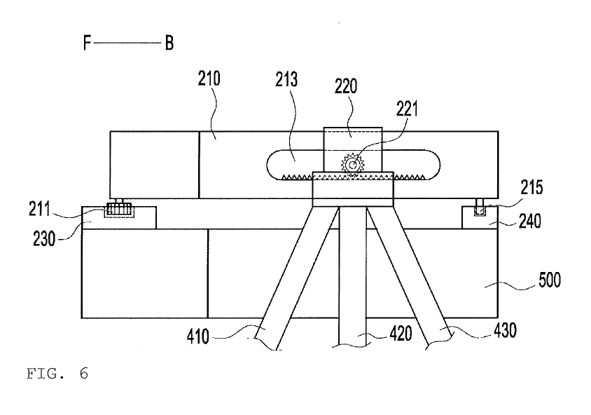

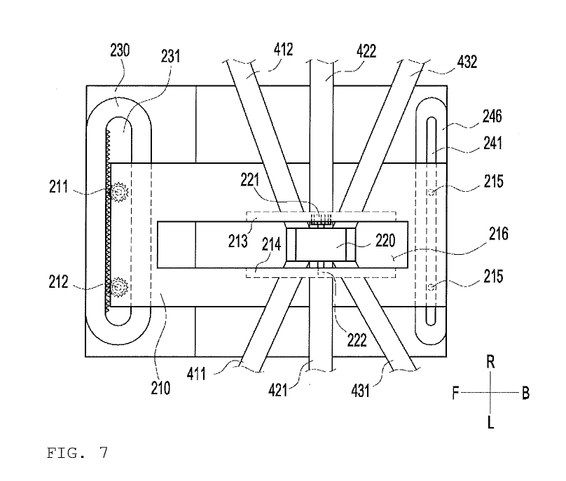

FIG. 5 is a perspective view of a driving module according to another embodiment of the present invention, FIG. 6 is a side view of the driving module according to another embodiment of the present invention, and FIG. 7 is a plan view of the driving module according to another embodiment of the present invention. A portion of a first moving body 210 having a second slit 241 is not shown in FIG. 6.

As shown in FIGS. 5 to 7, the driving module may include: a first motion guide 230 that is elongated left and right; a first slit 231 that is formed in the longitudinal direction on the first motion guide 230 and has teeth on a portion thereof; a second motion guide 240 that is spaced from the first motion guide 230 and elongated left and right; a second slit 241 that is formed in the longitudinal direction on the second motion guide 240; a first moving body 210 that is engaged with the first slit 231 and coupled to the second slit 241 to move straight left and right; and a second moving body 220 that is inserted in a hole 216 formed through the first moving body 210 and to be coupled to the first moving body 210 and is coupled to the first belt 410, second belt 420, and third belt 430 to move straight forward and rearward.

The first moving body 210 may have a third slit 213 formed on a first side of the hole 216 with teeth on a portion thereof, a fourth slit 214 formed on a second side facing the first side of the hole 216, a first moving gear 211 engaged with the teeth of the first slit 231 and providing force to the first moving body 210 by rotating by a first motion motor, and a first projection 215 coupled to the second slit 241 to maintain the motion direction of the first moving body 210.

The second moving body 220 may have a second moving gear 221 engaged with the teeth of the third slit 213 and providing force to the second moving body 220 by rotating by a second motion motor, and a second projection 222 coupled to the fourth slit 214 to maintain the motion direction of the second moving body 220.

The first moving body 210 can operate as a guide when the second moving body 220 is moved straight forward and rearward, and can operate the second moving body 220 such that the second moving body 220 is moved straight left and right. Accordingly, it is possible to pull and release the first belt 410, second belt 420, and third belt 430 coupled to the second moving body 220.

The first motion guide 230 and the second motion guide 240 may be coupled to the controller 500 that functions as the main body. Accordingly, the first motion guide 230 and the second motion guide 240 can be fixed and guide the first moving body 210.

The first moving body 210 may have a first auxiliary moving gear 212 engaged with the teeth of the first slit 231, spaced from the first moving gear 211, and not supplied with power. When the first moving body 210 is moved by force from the first moving gear 211, the first auxiliary moving gear 212 can be moved along the first slit 231 and assist the first moving body 210 to maintain balance and move straight in a predetermined direction.

A plurality of first projections 215 may be provided and spaced from each other with regular intervals therebetween, and may be guided along the second slit 241. Accordingly, the first moving body 210 can maintain balance and move straight is a predetermine direction.

The second moving body 220 can be moved straight forward or rearward by clockwise or counterclockwise rotational force of the second moving gear 221 engaged with the teeth of the third slit 213.

The fourth slit 214 guides the second projection 222, and as the second projection 222 is guided along the fourth slit 214, the second moving body 220 can be moved straight in a predetermined direction.

A sensing unit is disposed in each of the first slit 231 to the fourth slit 214 and the sensing units sense and transmit the positions of the first moving gear 211, the first projection 215, the second moving gear 221, and the second projection 222 to the controller 500, whereby the controller 500 can control the driving module using the information about the positions of the first moving gear 211, the first projection 215, the second moving gear 221, and the second projection 222.

The principle of controlling the pet 10 by the driving module is described hereafter.

As shown in FIGS. 3A to 7, the first belt 410 may be formed by combining a 1-1 belt 411 disposed at the left side of the driving module with a 1-2 belt 412 disposed at the right side of the driving module. Similarly, the second belt 420 may be formed by combining a 2-1 belt 421 disposed at the left side of the driving module with a 2-2 belt 422 disposed at the right side of the driving module, and the third belt 430 may be formed by combining a 3-1 belt 431 disposed at the left side of the driving module with a 3-2 belt 432 disposed at the right side of the driving module.

The controller 500 can determine whether the pet 10 is in a limited range that is a limited action radius on the basis of information transmitted from the sensor unit 510.

First, when the controller 500 determines that the pet 10 goes forward out of the limited range, the controller 500 determines to need to decrease the speed of the pet 10 or stop the pet 10 and transmits a control signal to the driving module, and the driving module can pull the 1-1 belt 411 and the 1-2 belt 412 rearward.

When the controller 500 determines that the pet 10 goes rearward out of the limited range, the controller 500 determines to need to increase the speed of the pet 10 and transmits a control signal to the driving module, and the driving module can pull the 3-1 belt 431 and the 3-2 belt 432 forward.

When the controller 500 determines that the pet 10 goes left out of the limited range, the controller 500 determines to need to adjust the movement direction of the pet 10 to the right and transmits a control signal to the driving module, and the driving module can pull the 2-1 belt 421 to the right. Further, when the controller 500 determines that the pet 10 goes left out of the limited range and the speed in increased, the controller 500 determines to need to decrease the speed of the pet and adjust the movement direction to the right and transmits a control signal to the driving module, and as shown in FIG. 3B, the driving module can pull the 2-1 belt 421 and the 1-1 belt 411 to the right and rearward. Further, when the controller 500 determines that the pet 10 goes left out of the limited range and the speed is decreased, the controller 500 determines to need to increase the speed of the pet and adjust the movement direction to the right and transmits a control signal to the driving module, and the driving module can pull the 2-1 belt 421 and the 3-1 belt 431 to the right and forward.

When the controller 500 determines that the pet 10 goes right out of the limited range, the controller 500 determines to need to adjust the movement direction of the pet 10 to the left and transmits a control signal to the driving module, and the driving module can pull the 2-2 belt 422 to the left. Further, when the controller 500 determines that the pet 10 goes right out of the limited range and the speed is increased, the controller 500 determines to need to decrease the speed of the pet and adjust the movement direction to the right and transmits a control signal to the driving module, and the driving module can pull the 2-2 belt 422 and the 1-2 belt 412 to the left and rearward. Further, when the controller 500 determines that the pet 10 goes right out of the limited range and the speed is decreased, the controller 500 determines to need to increase the speed of the pet and adjust the movement direction to the right and transmits a control signal to the driving module and, as shown in FIG. 3A, the driving module can pull the 2-2 belt 422 and the 3-2 belt 432 to the right and forward.

When the driving module pulls the belts and the pet 10 remains in the limited range, the driving module can release the belts.

The belts are controlled in the ways described above in an embodiment of the present invention, but the present invention is not limited thereto.

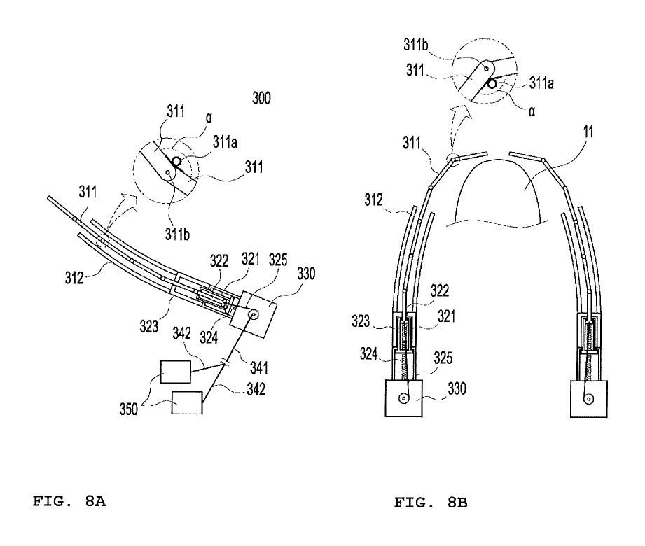

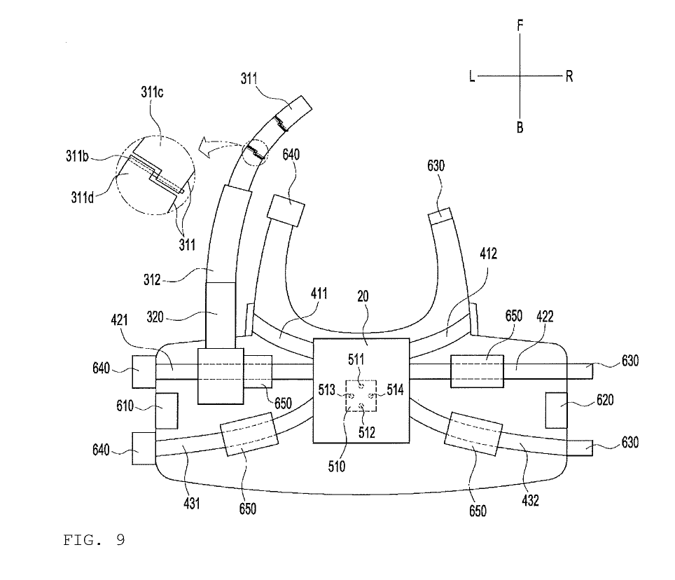

FIGS. 8A and 8B are views showing the internal structure of a third driving unit according to an embodiment of the present invention and FIG. 9 is a plan view of the wearing part 600 according to an embodiment of the present invention. FIG. 8A shows the internal structure of a third driving unit 300 with a cover unit 310 contracted in a cover unit housing 312 and FIG. 8B shows the internal structure of the third driving unit 300 with the cover unit 3100 stretched out of the cover unit housing 312. In FIG. 9, the cover unit 310 has been stretched out of the cover unit housing 312.

As shown in FIGS. 1, 8A and 8B, and 9, the apparatus for controlling a pet of the present invention may further include a third driving unit 300 including the cover unit 310 that covers the mouth 11 of the pet, a stretcher unit 320 that is coupled to the cover unit 310 and changing in length to operate the cover unit 310, and a third motor unit 330 that provides force for contracting the stretcher unit 320.

The cover unit 310 includes a plurality of cover member 311 coupled to each other by pins 311b and contracts into and stretches out of the cover unit housing 312, and when the cover unit stretches out of the cover unit housing 312, an internal angle α is defined between the cover members 311.

The cover members 311 may be rectangular plates made of synthetic resin or light metal and may have holes for coupling by pins 311b. The coupling by the pins 311b is made in the same or similar way as general hinges. As shown in FIGS. 8A to 9, a bottom hole 311d in which a pin 311b can be inserted is formed at the lower end of a side of one cover member 311 and a top hole 311c in which a pin 311b can be inserted is formed at the upper end of a side of another cover member 311, so the cover members are coupled by overlapping the top hole 311c and the bottom hole 311d and then inserting a pin 311b into the top hole 311c and the bottom hole 311d simultaneously.

A torsion spring 311a is disposed between the cover members 311. Accordingly, when the cover unit 310 contacts into the cover unit housing 312, the torsion springs 311a unfold the cover members 311 at both sides by applying elasticity, and when the cover unit 310 stretches out of the cover unit housing 312, the torsion springs 311a return to its original state to make the internal angles a between the cover members 311, whereby the cover unit 10 can cover the mouth 11 of the pet.

Although the torsion spring 311a is disposed between the cover members 311 in an embodiment of the present invention, the present invention is not limited thereto and a spring or a rubber elastic member may be used.

The cover unit 310 may be used to prevent attack using the mouth 11 of the pet when the pet 10 is excited to be aggressive.

The stretcher unit 320 may include a stretcher unit housing 323, a first stretcher 321 that contracts into or stretches out of the stretcher unit housing 323, a second stretcher 322 that contracts into or stretches out of the first stretcher 321, and a stretcher spring 324 that is coupled to the second stretcher 322 through the first stretcher 321 and applies elasticity to the first stretcher 321 and the second stretcher 322. Although the stretcher unit 320 formed in multiple steps has the first stretcher 321 and the second stretcher 322 in an embodiment of the present invention, the present invention is not limited thereto and more stretchers such as a third stretcher and a fourth stretcher may be provided.

The third motor unit 330 and the second stretcher 322 may be connected to each other by a stretcher wire 325. When the cover unit 310 stretches out of the cover unit housing 312, the stretcher wire 325 wound in the third motor unit 330 is unwound from the motor unit 330, the first stretcher 321 is stretched out of the stretcher unit housing 323 by elasticity of the stretcher spring 324, the second stretcher 322 is stretched out of the first stretcher 321, and the first stretcher 321 pushes out the cover unit 310, whereby the cover unit 310 can be stretched out of the cover unit housing 312. Further, when the cover unit 310 contracts into the cover unit housing 312, the stretcher wire 325 is wound into the third motor unit 330, the first stretcher 321 contracts into the stretcher unit housing 323, and the second stretcher 322 contracts into the first stretcher 321, whereby the cover unit 310 can be contracted into the cover unit housing 312.

The cover unit may have a spray that can spray fragrant chemical substance. The pet 10 can easily calm down itself by inhaling a fragrant chemical substance when it is excited. Accordingly, when a gyro sensor on the wearing part 600 makes the controller 500 recognize excitement of the pet 10 by transmitting a rapid change of the center of gravity of the pet 10 and the controller 500 transmits a signal to the spray, or the owner of the pet 10 transmits a control signal to the spray by operating his/her electronic device so that the spray forces out the chemical substance, whereby it is possible to control excitement of the pet 10.

As described above, the sound unit in the case 20 may be disposed on the cover unit. In addition to the function described above, the sound unit may send out music to the pet 10.

As shown in FIGS. 1 to 8A, the apparatus for controlling a pet of the present invention may further include leg restrictors 350 that are connected to a wire 340 coupled to the third motor unit 330 and restrict legs of the pet 10 by moving to joints of the legs of the pet 10 from the upper parts of the legs of the pet 10.

In detail, as shown in FIG. 8A, the wire 340 may be composed a first wire 341 and a pair of second wires 342, in which a first end of the first wire 341 may be coupled to the third motor unit 330, first ends of the second wires 342 may be coupled to the leg restrictors 350, respectively, and a second end of the first wire 341 and second ends of the second wires 342 may be connected to each other.

Accordingly, when the pet 10 is excited, the first wire 341 wound in the third motor unit 330 is unwound and the leg restrictors 350 are moved down to the joints of the legs of the pet 10 from the upper parts of the legs of the pet 10 by gravity, thereby being able to restrict the legs of the pet 10.

As shown in FIG. 9, the apparatus for controlling a pet of the present invention may further include a sensor unit 510 that is disposed in the case 20, includes a plurality of position sensors, and transmits information about the distances between the electronic device and each of the position sensors to the controller 500.

The sensor unit 510 may include a first position sensor 511 that senses a forward position change of the pet 10, a second position sensor 512 that senses a rearward position change of the pet 10, a third position sensor 513 that senses a left position change of the pet 10, and a fourth position sensor 514 that senses a right position change of the pet 10.

The electronic device can measure in real time the distances from the first position sensor 511 to the fourth position sensor 514, and can set a limited range that is the limited action radius of the pet 10 on the basis of the distances from the position sensors and transmit information about the distances to the controller 500. When the pet 10 goes out of the limited range, it is possible to control the pet 10 by operating the driving module.

A detailed embodiment was described above in relation to the principle of controlling the pet 10 by operating the driving module.

As shown in FIG. 9, the wearing part 600 includes a magnet unit 610 that is disposed at a first end of both ends, which are brought in contact with each other when the wearing part 600 is worn, of the wearing part 600, and a warning unit 620 that is disposed at a second end of both ends, which are brought in contact with each other when the wearing part 600 is worn, of the wearing part 600 and transmits an error signal to the controller 500 by a change in magnetism when it is spaced from the magnet unit 610. The magnet unit 610 and the warning unit 620 generate an error signal on the basis of magnetic attachment/detachment, but the present invention is not limited thereto, and a switch or a sensor may be included on the warning unit 620 such that the switch or the sensor is operated to create and transmit an error signal to the controller 500 when the wearing part 600 is taken off in order the achieve the same function.

When the warning unit 620 transmits an error signal to the controller 500, the controller 500 can transmit the error signal to the electronic device such that the electronic device visually and aurally generates a warning signal, and the warning unit 620 itself may visually and aurally generate a warning signal.

Although it is shown in FIG. 1 that the second belt 420 and the third belt 430 are simply wound around the wearing part 600, the second belt 420 and the third belt 430 may be coupled to the wearing part 600 through guides 650, as shown in FIG. 9.

First connecting portions 630 and second connecting portions 640 may be formed on the wearing part 600 such that the first connecting portions 640 are inserted into the second connecting portions 640, so when the wearing part 600 is worn on the pet 10, it can be fixed on the body of the pet 10.

The wearing part 600 may further have a neck belt that is wound around the neck of the pet 10 and a string connected to the neck strap enabling an owner of the pet 10 to hold it and control the pet 10. Accordingly, when there is an error in the apparatus for controlling a pet of the present invention or the pet 10 is not controlled by the force of the driving module, it is possible to directly control the pet 10 using the string.

A plurality of LEDs may be arranged at front/rear and left/right on the top of the case 20 to be turned on or off to indicate the directions when the pet 10 is controlled in the directions. In detail, when the pet 10 is controlled to the right, the right LED can be turned on.

The electronic device may be a smartphone or a tablet PC that the owner of the pet 10 can carry, a fixed computer system, or a control device separately manufactured to remotely control the pet 10.

The apparatus for controlling a pet of the present invention may further include a camera unit that is disposed on the case 20 and can observe the surrounding environment in the view point of the pet 10, and lamp units that are disposed at front/rear and left/right on the top of the case 20 and emit light so that the movement direction of the pet 10 can be visually shown.

The sensor unit 510 may include a biometric sensor that measures the biological rhythm and heartbeats of the pet 10, a GPS sensor that can locate the pet 10, and a gyro sensor that can measure a change in the center of gravity of the pet 10.

According to the present invention, it is possible to wirelessly control a pet, so it is possible to improve self-regulation of a pet and convenience for an owner when he/she lives indoor or goes out with the pet.

Further, the apparatus is manufactured to have a small size, small volume, and light weight with a simple configuration, so it does not give a pet wearing the apparatus inconvenience.

The effects of the present invention are not limited thereto and it should be understood that the effects include all effects that can be inferred from the configuration of the present invention described in the following specification or claims.

The above description is provided as an exemplary embodiment of the present invention and it should be understood that the present invention may be easily modified in other various ways without changing the spirit or the necessary features of the present invention by those skilled in the art. Therefore, the embodiments described above are only examples and should not be construed as being limitative in all respects. For example, single components may be divided and separate components may be integrated.

The scope of the present invention is defined by the following claims, and all of changes and modifications obtained from the meaning and range of claims and equivalent concepts should be construed as being included in the scope of the present invention.

1. An apparatus for controlling a pet, the apparatus comprising:
a driving module that is connected to a first belt configured to be wound between a neck and front feet of a pet, a second belt configured to be wound around a chest and back of a pet, and a third belt configured to be wound around a stomach and back of a pet to pull or release at least one of the first belt, the second belt, and the third belt;
a controller configured to receive and transmit control signals from an electronic device to driving units;
a case in which the driving module and the controller are disposed; and
a wearing part that is coupled to the case, the first belt, the second belt, and the third belt, and to be worn on the pet.

2. The apparatus of claim 1, wherein the driving module includes:
a moving body that has a first hole at an upper portion and a second hole formed at a lower portion with a central axis perpendicular to a central axis of the first hole and that is coupled to the first belt, the second belt, and the third belt to move forward/rearward and left and right;
a first guide that is disposed through the first hole;
a second guide that is disposed through the second hole;
a pair of first driving units that is coupled to both ends of the first guide to move straight the moving body forward/rearward; and
a pair of second driving units that is coupled to both ends of the second guide to move straight the moving body left/right.

3. The apparatus of claim 2, wherein the first driving units each include:
a first driving belt that is coupled to the first guide an outer side and has teeth on an inner side;
a first motor unit that has a first gear engaged with teeth on the inner side of the first driving belt and configured to drive the first driving belt by rotating the first gear; and
first sensing units that sense motion of the first guide.

4. The apparatus of claim 2, wherein the second driving units each include:
a second driving belt that is coupled to the second guide on an outer side and has teeth on an inner side;
a second motor unit that has a second gear engaged with teeth on the inner side of the second driving belt and that is configured to drive the second driving belt by rotating the second gear; and
second sensing units that sense motion of the second guide.

5. The apparatus of claim 1, wherein the driving module includes:
a first motion guide that is elongated left and right;
a first slit that is formed in a longitudinal direction on the first motion guide and has teeth on a portion thereof;
a second motion guide that is spaced from the first motion guide and elongated left and right;
a second slit that is formed in a longitudinal direction on the second motion guide;
a first moving body that is engaged with the first slit and coupled to the second slit to move straight left and right; and
a second moving body that is inserted in a hole formed through the first moving body and configured to be coupled to the first moving body and is coupled to the first belt, the second belt, and the third belt to move straight forward and rearward.

6. The apparatus of claim 5, wherein the first moving body has:
a third slit that is formed on a first side of the hole with teeth on a portion thereof:
a fourth slit that is formed on a second side facing the first side of the hole;
a first moving gear that is engaged with teeth of the first slit and that is configured to provide force to the first moving body by rotating by a first motion motor; and
a first projection that is coupled to the second slit to maintain a motion direction of the first moving body.

7. The apparatus of claim 6, wherein the second moving body has:
a second moving gear that is engaged with teeth of the third slit and that is configured to provide force to the second moving body by rotating by a second motion motor; and
a second projection that is coupled to the fourth slit to maintain a motion direction of the second moving body.

8. The apparatus of claim 1, comprising:
a third driving unit that includes a cover unit configured for covering a mouth of a pet, a stretcher unit coupled to the cover unit and changing in length to operate the cover unit, and a third motor unit providing force for contracting the stretcher unit.

9. The apparatus of claim 8, comprising:
leg restrictors that are connected to a wire coupled to the third motor unit and configured to restrict legs of a pet by moving to joints of the legs of the pet from upper parts of the legs of the pet.

10. The apparatus of claim 1, comprising;
a sensor unit that is disposed in the case, and includes a plurality of position sensors, configured to transmit information about distances between the electronic device and each of the position sensors to the controller.
